(19) United States
(12) Patent Application Publication
(10) Pub. No.: US 2003/0148801 A1
(43) Pub. Date: Aug. 7, 2003

(54) Signalling protocol for signalling start of reset processing in serial ATA bus protocol

(76) Inventors: Klaus-Peter Deyring, Scotts Valley, CA (US); James Rubino, Santa Cruz, CA (US); Scott Richmond, Boulder, CO (US)

Correspondence Address: RONALD CRAIG FISH, RONALD CRAIG FISH, A LAW CORP., POST OFFICE BOX 2258, MORGAN HILL, CA, 95037, US

(21) Appl. No.: 10/061,883

(22) Filed: Feb. 1, 2002

(51) Int. Cl. H04B 1/00

(52) U.S. Cl. 455/701; 455/72

(57) ABSTRACT

A method for transmitting a unique signal pattern on a serial bus to indicate the need for processing to re-establish synchronous communications on said bus, especially at power up, awaken from sleep or upon a fault such as loss of synchronization. The method comprises sending one or more silent intervals on a bus which normally requires transmission of data or fill characters at all times to maintain synchronization. The silent interval(s) have a predetermined duration and a predetermined sequence of durations if the durations of each interval are different and more than one interval is used. The predetermined pattern is known to all transceivers coupled to the bus. A long silent interval of a predetermined duration which is also known to all transceivers is sent at the end of the unique pattern to indicate the end of transmission thereof. A low power receiver monitors the bus at all times and listens for silent intervals and measures the durations thereof. This data is compared to stored data which defines the pattern of the unique signal, and reset processing is started when the pattern is recognized.

### FIELD OF USE

The invention is useful in the ATA serial bus protocol or any other serial bus protocol wherein the bus can lose synchronization or goes into sleep mode and needs to be re-established for active serial data communication. Currently, many disk drives in desktop personal computers and laptops are connected to a parallel format ATA bus. The parallel cable is a ribbon cable with a host of individual wires bound into a plastic insulator so as to be flat and wide. The wide nature of the cable interfered with cooling airflow inside the computer, which gets to be a significant problem as the switching rates of the circuitry rise with the ever-increasing clock speed.

Further, the parallel wires cause parasitic capacitances between the wires, which sap away energy in the high frequency Fourier components of high-speed, digital data signals being driven on the lines. This tends to round off the corners of step function digital transitions and alter the rise time of these signals. This limits the application of such a bus for extremely high clock rate traffic to and from the disk drive. There are many other problems with the parallel ATA buses inside computers such as echoes caused by the lack of termination, the possibility that connectors can be plugged in upside down, etc.

There is an ever-present need to drive data to and from disks at ever-higher rates, so a movement arose to convert from the parallel ATA bus configuration to a serial bus configuration. This created a need for a whole new set of serial communication protocols capable of bi-directional digital data transfer at very high rates. A coalition of companies was formed to develop the protocols. Each company is allowed to patent the innovations they developed to solve various ones of the problems that needed to be solved for creation of the new standard. If an innovation was adopted by the group, it would be placed in the specification for the new standard. The specification for the standard was developed by the group under non-disclosure agreements signed by each member of the group.

One of the problems that needed to be solved was how to signal the transceivers at each end of the bus that reset processing of the so-called OOB interval needed to start when anything went wrong with the transfers of data over the bus. The OOB interval is an interval on the bus when processing is performed to recognize that an OOB interval is needed, to calibrate the bus and do many other things that are not relevant to the invention. The invention described herein only has to do with recognition of the start of the OOB interval and how that start can be signaled to other transceivers coupled to a serial ATA bus.

Serial data transfer, where the clock is not transmitted on a separate line (the serial ATA bus only has three lines in each direction, two for a differential signal, and one ground line) requires that the receiving transceiver recover the clock used by the transmitter to send the data, and keep the receiving transceiver clock in synchronization with that transmit clock. When something goes wrong with this process, the receiving transceiver has lost synchronization and cannot receive any data. When this happens, a reset processing must be performed to fix whatever problem has occurred and get both sending and receiving transceivers in synchronization with each other. The problem then is how to send a signal to all transceivers coupled to the serial ATA bus that cannot be mistaken for data and which clearly indicates that the bus is “broken” and the reset processing needs to start. The applicant's devised such a signaling protocol, and this innovation was adopted by the group developing the serial ATA bus standard. This innovation is referred to in the serial ATA bus standard as the OOB protocol.

Another big problem that needed to be solved was the fact that laptops use ATA buses and are power limited because of the limited power of the battery. To conserve power, the laptop disk drives and displays are powered down after a predetermined period of nonuse to conserve battery power. In conventional serial communications at high speeds, the serial data transmitters have to transmit data at all times even if it is only fill data so that the receiver can recover the transmit clock from the transmit data itself and stay in synchronization. This is a problem for laptops since to keep the high power transceivers transmitting fill data during the sleep interval uses up the battery. A way to put the disk drives to sleep, shut off the high power transceivers and then monitor for a wake up signal using a low power receiver was needed. The OOB protocol which forms part of the teachings of the invention allows this to be done.

This OOB protocol innovation was put in the serial ATA bus specification Version 1.0. That specification for the new serial bus ATA standard meant to replace parallel ATA buses in desktop and laptop personal computers was developed by the serial ATA coalition from proposals made by members of the coalition and was published on Aug. 29, 2001. The new serial bus ATA protocol with the OOB signaling protocol in operation was first publicly used at the serial ATA bus trade show in February of 2001.

### SUMMARY OF THE INVENTION

The teachings of the invention contemplate a method of and apparatus for signaling the start of an OOB interval using a signal, which cannot be mistaken for data whenever a serial ATA bus is first powered up, awakened from a sleep interval, or when something has gone wrong with data transfers on the bus, such as loss of synchronization. In the preferred embodiment, the signal sequence that is used to signal the start of an OOB interval is at least three consecutive periods of silence on the bus, (silence also known in differential serial bus signaling as “common mode”) of predetermined lengths (all the same predetermined lengths in the preferred embodiment) separated by the transmission of any data for a predetermined interval. This preferred embodiment is only one species within the genus of the invention, however. The genus of the invention is defined by any protocol that requires transmission of at least one silent interval of a predetermined length the termination, of which is defined by the transmission of a burst of any data followed by transmission of a long silent intervals serving as an “over” signal, which indicates the transmitter is done sending the OOB “chirp”, i.e., the pattern of silent intervals followed by a burst of any data, said “over” signal indicating to other transceivers that they may now send back any handshake signal, which acknowledges receipt of the OOB chirp. The silent period of the “over” signal must be longer than longest silent interval in the OOB “chirp”. The duration of data bursts after the silent intervals to signal the end of the silent interval is not measured because the existence of the data burst is only necessary to define the end of the silent interval after silence of a predetermined duration. It is the silence having a predetermined duration or pattern thereof which serves as the OOB chirp, and is the long silence of a predetermined duration after the OOB chirp that serves as the “over” signal. The “over” signal is necessary because phase two of the OOB reset processing (which is not part of the invention) is to begin sending data back and forth between transceivers #1 and #2 for training, so the transmitters of both transceivers #1 and #2 are needed to do this. Therefore, transceiver #1 must first stop sending the OOB chirp before phase 2 can be entered. This happens after the “over” signal is sent and transceiver #2 sends back its handshake signal indicating receipt of the OOB chirp.

The handshake signal could be anything that can be reliably received and which can be distinguished from regular data. In the preferred embodiment, the handshake signal is another OOB pattern. However, if, for example, the OOB pattern was a chirp of three OOB blocks, the handshake could be a single OOB block, or the “over” signal sent back to transceiver #1, or a silent interval of a predetermined duration, which is different than any silent interval in the OOB chirp or the “over” signal.

The duration of the silent interval(s) in the OOB chirp must be known to all transceivers coupled to the serial ATA bus and responsible for monitoring for occurrence of the OOB pattern. In most species of the invention, at least two silent intervals of predetermined duration are used (which do not have to be the same duration) with the duration known to all transceivers (or at least all the low power transceivers) coupled to the bus (on either a differential or single ended serial bus).

These silent intervals are separated by bursts of any data of any length (which do not have to be the same in duration) and which serve only to mark the end of the silent interval that is being measured by whatever receiver is tasked with monitoring for the OOB signal. It is the exact length of the silent interval or a predetermined pattern of lengths of consecutive silent intervals, which is the OOB signal. Whatever the predetermined length(s) of the silent intervals are and the sequence of these lengths if they are not all the same, must also be known to all transceivers responsible for monitoring for the presence of the OOB signal coupled to the bus.

Any apparatus that can transmit such a known pattern and/or detect such a pattern is within the genus of the invention. Basically, the pattern can be any pattern of signals that would never occur in conventional serial data. Silent intervals never occur in conventional serial data transmissions, so they are a good choice but not necessarily the only choice. It is important to understand that even though the silent intervals are all the same length in the preferred embodiment and in FIGS. 1 and 2, the silent intervals do not have to all be the same length to be recognizable nor do they have to be limited to a minimum of three nor does there have to be more than one silent interval. Any number will do. A minimum number of two consecutive silent intervals of predetermined durations may be more reliable than a single silent interval of a predetermined duration since a single silent interval of the predetermined length could conceivably result in the case a transmitter failed intermittently and went silent for the predetermined time and then started up again. For an intermittent transmitter, it is less likely that the transmitter would go silent two consecutive times for the predetermined duration and then fail again to send the “over” signal. But the probability that a transmitter would fail intermittently and send a silent interval of the exact predetermined interval followed by the transmission of data is also very low.

### BRIEF DESCRIPTION OF THE DRAWINGS

FIG. 1 is a diagram of the actual OOB signal which is transmitted to signal the start of a OOB reset interval or an OOB interval which is necessary upon power up.

FIG. 2 is a diagram of another format OOB ,signal which is transmitted to signal a wakeup from sleep and start of an OOB period.

FIG. 3 is a block diagram of the environment in which the invention works.

FIG. 4 is a flow chart of the OOB protocol for processing by both ends of a serial ATA bus to start an OOB reset interval.

FIG. 5 is a block diagram of portions of the conventional high power transceiver circuitry on a serial ATA bus and the low power receiver circuitry that monitors for the presence of an OOB signal.

### DETAILED DESCRIPTION OF THE PREFERRED AND ALTERNATIVE EMBODIMENTS

When high-speed serial links first power up, they cannot begin to immediately communicate. The sending and receiving transceivers first need to perform processing to establish synchronization and exchange messages to determine each others capability and agreeing upon the protocol to communicate within the serial ATA bus standard. This same process must be repeated when one of the communicating transceivers loses synchronization. When this reset processing is necessary, there is a need for one of the transceivers, which knows there is a problem to send a signal to the other transceiver, or all other transceivers on the bus, if there are more than two, which tells all transceivers that there has been a failure or there is otherwise a need to execute the reset processing to get communication going. This signal, which will be referred to herein as the OOB signal, must be a unique signal, which cannot be mistaken for data. This signal effectively acts as an interrupt or wake up call to tell all transceivers to stop what they are doing and execute their reset processing to get communications back on track.

Another problem is in waking up laptop or other battery operated computer hard drives from power saving sleep mode with a signal that operates as a wake up call but which can be listened for by a low power receiver. Laptops are energy-starved devices. They have limited battery life, and the serial ATA bus circuitry is high power circuitry since it drives data at tremendous speed to the hard drive and from the hard drive. In addition, the hard drive eats up battery power. Therefore, most laptops have a sleep mode which is either automatically entered after a predetermined time or which can be entered manually. During sleep mode, the hard drive motors are shut down to conserve power and the high power transceiver circuitry is powered down. However, this circuitry must be awakened again when the owner wants to use the laptop. So, there is a need for low power circuitry to monitor for the wakeup call of an OOB signal and send a signal to the computer's operating system, or other software processes, to wake up the hard drive, power up the transceiver circuitry, and execute the reset processing to get serial ATA bus communications up and running again.

In normal serial communications, both transmitters have to continuously send either data or fill characters so that the receiver at the other end can recover the clock and keep its clock continuously synchronized with the transmitter's clock. Thus, a silent interval is something that is very out of the ordinary in a serial communication link, and this fact is used to advantage in composing the OOB signal.

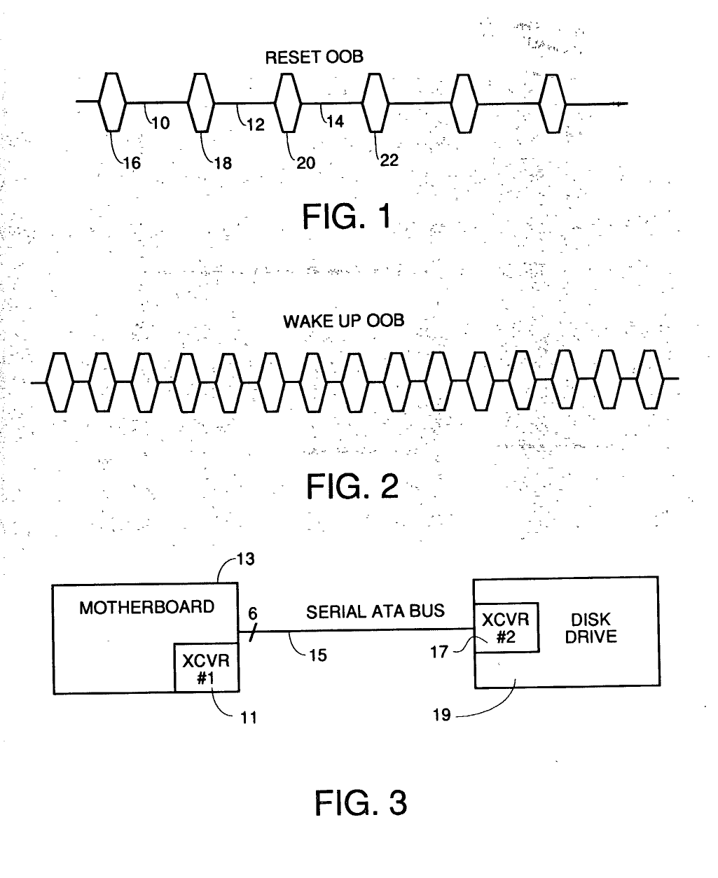

Referring to FIG. 1, there is shown a diagram of the OOB signal that is used in the preferred embodiment to signal a reset or initiation of an OOB reset interval. This particular species uses three consecutive common mode (silent) intervals 10, 12 and 14 which are all of a predetermined duration (320 nanoseconds) terminated on the end by a burst of any data which are all of a predetermined duration (106.7 nanoseconds). A single silent interval followed by a burst of data is one unit. In the preferred embodiment, transmission of three consecutive units is the OOB signal-pattern that all receivers are looking for to trigger an OOB interval.

A silent interval in serial differential signaling is both transmit signal lines 25 and 27 in FIG. 3 being within 50 millivolts of each other. The term “any data” means that anything other than a silent line is transmitted for the predetermined time. It is much easier to detect that something has been transmitted than to detect what was transmitted especially when synchronization has been lost. When synchronization has been lost, it is still possible to detect that something is being sent. This fact is used to advantage in the OOB signal protocol. In the genus of the invention, of which FIG. 1 is a species, it is not critical that three consecutive silent intervals be used, or that they all be the same length, or that each silent interval be bounded on both ends by some data burst, or that all the data bursts be the same length. It is only important that whatever the pattern is, it must be a pattern which does not occur in regular data and that all the transceivers coupled to the bus be aware of what the pattern is. In the broadest definition of the genus, a single silent interval of a predetermined duration followed by a single burst of any data (the duration of which is not measured in the preferred embodiment but which could be measured in some species) would suffice to practice the invention. In such an embodiment, the mere failure of a transceiver which falls silent would not trigger the OOB reset interval because a receiver that fails will fall silent and not transmit a silent interval of a predetermined followed by a burst of data.

FIGS. 1 and 2 show two different types of OOB signals. The only difference between them is the length of the silent intervals. In FIG. 2, the silent intervals are all the same duration of 106.7 nanoseconds and the data burst following each silent interval is also 106.7 nanoseconds but the length of that data burst is actually not measured so it could be any length. The serial ATA specification does call for a specific length of the data burst, but for purposes of the invention, the length of the data burst is not part of the OOB pattern and only the fact that some data burst occurred which marked the end of the silent interval at the predetermined time after it started is part of the OOB pattern.

The OOB signal of FIG. 2 is used to signal the start of a wakeup from sleep OOB interval whereas the OOB signal of FIG. 1 is used to signal the start of a reset or initial OOB interval which happens at power up or whenever synchronization or other problems cause the bus the “break”. The processing that occurs during these two different types of OOB intervals may be different, but that is not part of the invention.

Although the serial ATA specification calls for a specific pattern of silent intervals of specified duration followed by a burst of any data of a specified duration, for purposes of the invention, any pattern of silent intervals of predetermined duration(s) separated by data bursts of any reasonable duration can be used so long as the selected pattern is not found in regular data. The duration of the silent periods and the duration of the data bursts within a species of the invention do not have to be the same as in the serial ATA specification, but to be compatible therewith these duration do need to be as specified. Further, the duration of the silent intervals do not need to be the same from one OOB block to the next (an OOB block is one silent interval followed by one data burst) nor does there need to be more than one OOB block.

In reality, when, for example, the user presses the reset button, the OOB signal will be transmitted millions of times as the user holds the button down, but really only one block of the predefined sequence of silence of a predetermined duration followed by a data burst is needed to start the OOB interval. The predetermined sequence of OOB blocks is together referred to herein as the OOB signal or the OOB chirp. A long silent interval of a predetermined duration which is longer than any silent interval in the OOB chirp and which occurs after the OOB chirp serves as the “over” signal which tells the transceiver on the other end when to send its handshake signal. The sending of a handshake signal is not a defining characteristic of the genus since some species may not require a handshake and therefore will not send the “over” signal.

The predetermined pattern of the OOB chirp must be known in advance by all transceivers or low power transceivers coupled to the bus. In many species, the intervals of the data bursts following the silent interval are not measured and they are necessary only to define the end of the silent interval.

Referring to FIG. 3, there is shown a block diagram of the environment in which the invention works. Transceiver #1 shown at 11 on motherboard 13 transmits over serial ATA bus 15 to transceiver #2 shown at 17 on disk drive 19. The serial bus is shown as having 6 wires which differential signaling serial ATA buses have. However, the invention is also applicable to other serial buses which are single ended and have a different number of wires. Typically, both the motherboard and the disk drive will be in a personal computer, which can be either a desktop or a laptop.

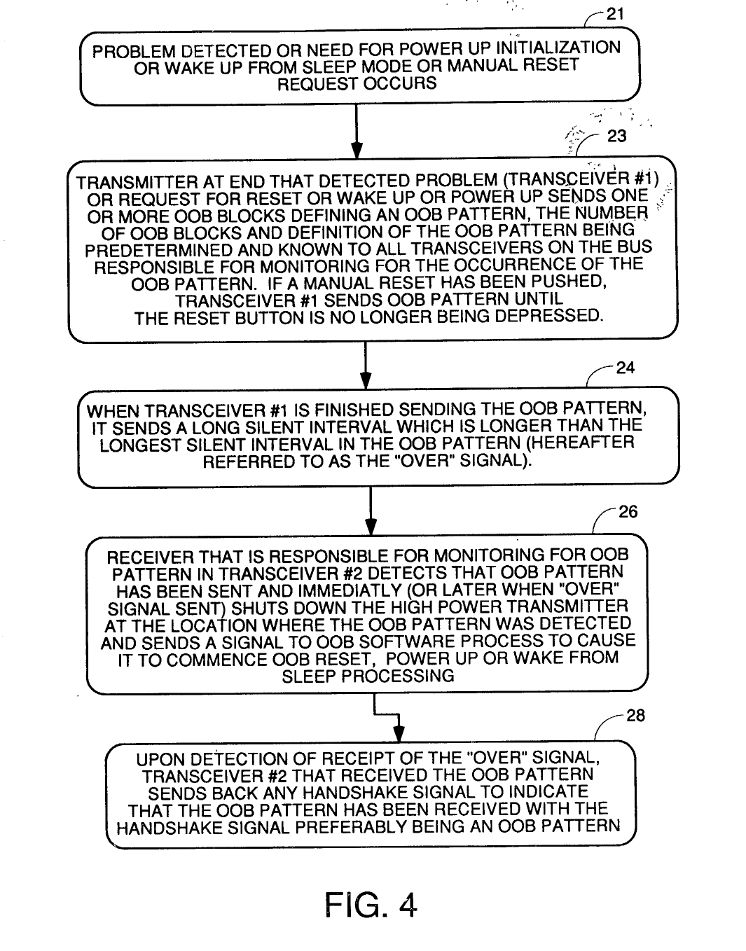

Referring to FIG. 4, there is shown a flowchart of the OOB protocol in terms of the events that happen and the signals transmitted in an environment such as that shown in FIG. 3. Step 21 represents the process of detecting that an event calling for an OOB reset interval has occurred. This can be anything such as the user pressing the restart button or giving a software restart command, or a determination that a power up event has just occurred or that any key has been pressed while the computer is in sleep mode. In addition, the software can detect a fault and call for a system reset. All of these possible sources of a reset signal from the motherboard and the drive are combined in an OR gate on the motherboard and a corresponding OR gate on the drive to generate a master reset signal in both places. Step 21 represents the process of determining that the master reset signal has entered the active state either on the motherboard or the drive. Step 21 also includes the process of sending a signal to the transceiver on the unit whose master reset signal entered an active state commanding the transceiver to send the OOB chirp. Step 23 represents the process of the transceiver at the unit, which detected the need for the OOB reset interval sending the predetermined OOB signal. Typically, when a reset button is pushed, the transceiver sends the OOB pattern until the reset button is no longer being pushed. In other cases, such as a software restart, detection of a communication fault, power up or wake up from sleep, the OOB pattern is sent for a predetermined time calculated to make sure that all transceivers coupled to the bus have had time to detect the presence of the OOB chirp. The OOB chirp that is sent is the appropriate one for the event detected if different types of OOB chirps for different events are in use such as are shown in the species of FIGS. 1 and 2. Step 23 basically represents the process of telling the transmitter to stop its normal transmissions and go to silence or common mode (silence on a differential pair). Since this silence is contrary to every tenet of serial communication which normally requires that real data or fill characters be transmitted at all times so that the receiver phase lock loops do not lose lock on the bit clock signal embedded in the data, the silence is easily detected as an unusual event. In some species, a single silent interval of a predetermined duration followed by a burst of data of any length suffices of the OOB chirp. In other species, two or more silent intervals of predetermined durations followed by bursts of data of any length serve as the OOB signal. In other species, a known pattern of silent intervals of different durations sent in a predetermined order and separated by data bursts of any length serve as the OOB pattern.

Step 24 represents the process of sending a long silent interval of a predetermined duration known to all transceivers on the bus 14 responsible for monitoring for the OOB chirp to serve as an “I am finished” or “over” signal. This signal is necessary to indicate to the other transceivers that the transceiver that sent the OOB chirp is done transmitting, and phase II of the OOB reset interval processing can begin wherein data is transmitted back and forth between transceivers #1 and #2 to reestablish synchronization, adjust impedance matches to minimize VSWR echoes, etc. This silent interval should be different (not necessarily longer in every species) than any silent interval in the OOB chirp so it can be distinguished from a silent interval which is part of the OOB chirp. This “over” signal must be sent after the master reset signal transitions to an inactive state which also causes the transceiver which is sending the OOB pattern to stop sending it.

Step 26 represents the process that happens in whatever receiver (usually a low power receiver but it could also be the high power bus receiver) is responsible for monitoring for the OOB signal to detect that the OOB chirp is being transmitted on the bus by some other transceiver. Assume that transceiver #1 sent the OOB chirp and transceiver #2 received it. In the preferred embodiment, transceiver #2, immediately upon recognizing that the OOB chirp has been received will send a signal to the MAC layer process or whatever other process is running that is responsible for doing the OOB processing that an OOB reset interval has just started. This part of the process is not optional since there is no point in sending the OOB chirp signal if transceiver #2 does not cause the OOB reset processing to start when the OOB signal is detected. Optionally, transceiver #2 also then sends a signal to its high power transmitter which causes that transmitter to stop sending data to transceiver #1 or whatever other transceivers are on the bus as soon the OOB chirp is detected or even as soon as the first silent interval of the OOB chirp is detected. This is preferred because if there is crosstalk between the serial bus wires, having transceiver #2 continue to transmit while the silent intervals are occurring could interfere with correct reception of the silent intervals. However, in some species within the genus of the invention, transceiver #2 does not have to shut its transmitter down until it is time to send the handshaking signal back to transceiver #1 or transmit other data which is part of the OOB processing.

Then, in step 28, transceiver #2 waits for detection of the “over” signal. When the “over” signal has been sent, transceiver #2 sends its handshake signal back to transceiver #1 acknowledging that the OOB chirp has been received. In the preferred embodiment, this handshaking signal is another OOB chirp, but it can be any other signal, which is clearly recognizable and not found in regular data. The transmission and reception of the handshaking signal is an event which is signaled to whatever process which is doing the OOB processing that stage 11 of the OOB process can begin.

After the “over” signal is detected and transceiver #1 receives the handshaking signal back, in the OOB protocol, transceiver #1 starts his calibration processing. This calibration processing involves transceiver #1 telling its receiver to ignore all incoming data and then using its transmitter to resend the OOB signal pattern. Transceiver #2 then starts its calibration process. Transceiver #2 sends back the OOB signal pattern when it is done calibrating and that is a signal to transceiver #1 that it can start the speed negotiation process. Transceivers #1 and #2 continue to carry out the various phases of the OOB reset processing and the OOB signal patterns are “ping ponged” back and forth to serve as handshaking signals and markers for the next phase of the OOB reset process. After OOB processing is finished, transceiver #1 starts sending legitimate 8 b/10 b encoded characters across the bus. Transceiver #2 echoes these characters back to the sender. Transceivers #1 and #2 are then synchronous with each other so transceiver #1 then sends a line followed by a sync character and the bus in back in synchronization at that point and legitimate payload data can be sent.

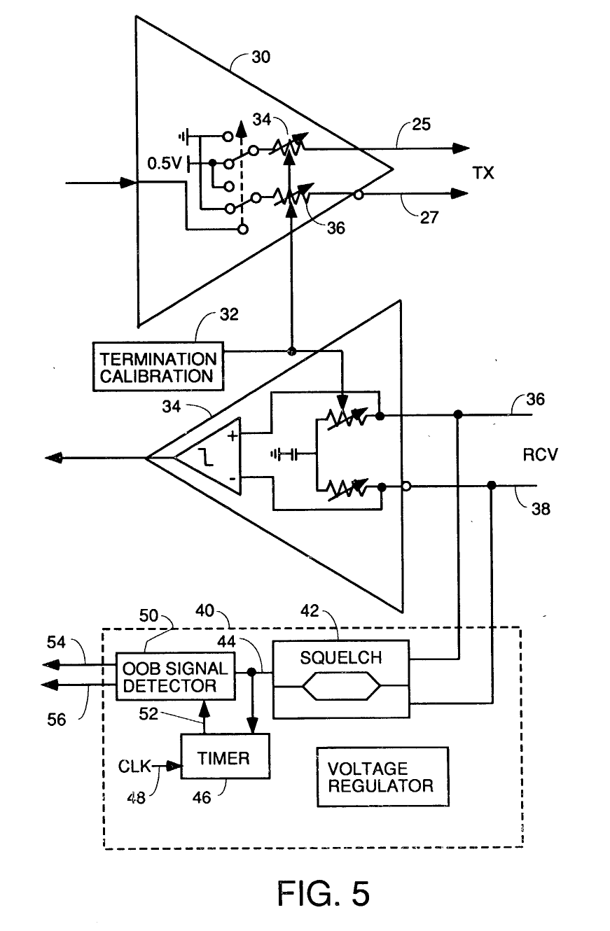

Referring to FIG. 5, there is shown a simplified block diagram of the physical layer high power transmitter and receiver circuitry of a serial ATA bus and the lower part of the figure shows the low power receiver circuitry that monitors for the receipt of an OOB signal. The serializer and de-serializer of the high power PHY layer receiver circuitry is not shown. A conventional high power transmitter 30 outputs very high speed 8 b/10 b encoded data on differential transmit pair 25 and 27. A conventional termination calibration circuit 32 controls the impedance of variable resistors 34 and 36 during a calibration interval of OOB reset processing to match the output impedance of the transmitter 30 to the input impedance of the differential pair to minimize reflections from bad voltage standing wave ratio conditions which occur if the output impedance is not properly matched to the line input impedance. A conventional high power receiver 34 has its inputs coupled to differential lines 36 and 38 of the receive pair on the serial ATA bus. The serial ATA bus is comprised of transmit lines 25 and 27 with an associated ground line (not shown) and receive lines 36 and 38 and an associated ground line (not shown).

A low power receiver 40 has its inputs coupled to lines 36 and 38 in parallel with the connections of the inputs of high power receiver 34. This allows the high power receiver to be turned off to conserve energy when the serial ATA bus and the motherboard, disk driver other circuitry of the computer is powered down during sleep mode while the low power receiver continues to monitor the bus for the OOB chirp during sleep. This is an important feature especially in laptop computers which have limited battery life. A conventional squelch circuit 42 determines when the signals on lines 36 and 38 are within 50 millivolts of each other thereby indicating a common mode signal or silent mode is being received. When the signals on lines 36 and 38 are within a predetermined voltage range from each other, squelch circuit sets its output signal on line 44 to logic 1. In a single ended receiver, squelch circuit 42 could be a simple comparator which compares the voltage on the single receive data line to a ground reference. The signal on line 44 returns to logic zero when the silent interval ends and any data is being transmitted on lines 36 and 38. During normal differential, serial data transmissions, lines 36 and 38 are swinging back in forth in voltage at all times to differential signal levels that encode the 8 b/10 b encoded data, and even if the bus has lost synchronization, the voltages on lines 36 and 38 are never common mode. Thus, when lines 36 and 38 are driven to common mode, this fact is very easy to detect since it is very unusual.

A timer/counter 46 counts clock cycles of a clock signal which is either generated internally or received on line 48 (either will suffice and there is no need for both). Counting starts when the signal on line 44 transitions to logic 1 and counting stops when the signal on line 44 transitions to logic 0. It is important to correct operation of the invention and the expense of the low power receiver that the tolerances on the durations of the silent intervals in the OOB chirp and the “over” signal at the end of the chirp be lenient enough that the timer 46 does not have to be a precision timer so that it can still be used with adequate accuracy to measure the duration of the silent intervals.

An OOB signal detector 50 also receives the signal on line 44 and has a data input 52 coupled to read the count in counter 46. The OOB signal detector is typically a state machine which reads the count in counter 46 at each transition of the signal on line 44 and compares the count at the beginning of each silent interval to the count at the end of each silent interval. From this data, the duration of each silent interval can be deduced since the clock period is known. The OOB signal detector then compares the duration of the one or more silent intervals and the pattern of the silent intervals, if more than one silent interval is used, to the known duration(s) and pattern of durations of the silent interval(s) to draw a conclusion as to whether an OOB pattern has been received. In the preferred embodiment, when the pattern of FIG. 1 is received, OOB signal detector 50 sets the signal on output line 56 to logic 1 and when the pattern of FIG. 2 is received, the output signal on line 54 is set to logic 1. The signals on lines 54 and 56 are held in a logic 1 state for as long as the OOB pattern is being sent on the bus.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A method of transmitting a unique signal on any serial bus that is different from any data transmitted on the bus and which, when transmitted, signals the start of predetermined reset, power up or awaken from sleep process, comprising:
a) transmitting one or more unique patterns that never occur in real data, each unique pattern comprised of a silent interval of a predetermined duration known to all transceivers coupled to said bus followed by transmission of a burst of any data to mark the end of said predetermined duration of said silent interval; and
b) transmitting a long silent interval of a predetermined length known to all transceivers coupled to said bus at the end of transmission of said one or more unique patterns as an “over” signal to signal the end of transmissions of said unique pattern, said silent interval of said “over” signal being of a different duration than any silent interval in said unique pattern.

2. The method of claim 1 further comprising the steps of monitoring said serial bus using a low power receiver in each transceiver coupled to said bus, each said transceiver having a higher power transmitter and a higher power receiver, and when said low power receiver detects the transmission of said unique signal on said sending a signal to a software process to cause reset processing, initial power up processing or wake up from sleep processing to commence.

3. The method of claim 2 further comprising the steps of using said low power transceiver to monitor for transmission of said “over” signal, and when one or more of said unique patterns are detected in a transceiver coupled to said serial bus, causing a high power transmitter in the transceiver which detected said unique pattern(s) to stop transmitting, and when said ‘over’ signal is detected, sending back to the transceiver which transmitted said unique pattern a unique handshake signal which does not occur in regular data.

4. The method of claim 3 wherein transmission of said unique handshake signal comprises transmission of said unique pattern signal back to the transceiver which sent said unique pattern to confirm receipt of said unique pattern.

5. The method of claim 1 wherein step 1 comprises transmitting at least two silent intervals, each of the same length, and separated by at least one burst of any data of any length.

6. The method of claim 1 wherein step 1 comprises transmitting at least three silent intervals, each of the same length, each silent interval separated from adjacent silent intervals and ended by transmission of a burst of any data of any relatively short length.

7. The method of claim 3 wherein transmission of said burst of data comprises transmitting a burst of any data at the end of each silent interval; each burst being of a predetermined length.

8. A method of transmitting a unique OOB pattern of signals on a serial ATA bus which could never be mistaken for data, comprising detecting the occurrence of a reset signal and responding thereto by transmitting a unique OOB pattern comprised of at least two silent intervals, each having a predetermined duration which may be different, said duration being known to all transceivers coupled to said serial ATA bus, said silent intervals, if of different lengths, occurring in a predetermined sequence which also is known to all transceivers coupled to said serial ATA bus, each silent interval separated from adjacent silent intervals and ended by a burst of any data, each said burst of data being of any duration, said duration of said data burst not forming part of said unique OOB pattern, and concluding transmission of said unique OOB pattern at the time said reset signal transitions to an inactive state and transmitting a long silent interval having a predetermined duration known to all transceivers coupled to said serial ATA bus, and serving as an “over” signal indicating transmission of said unique OOB pattern is finished, the duration of said “over” signal silent period being different than any silent interval in said unique OOB pattern.

9. The method of claim 8 further comprising the step of starting any reset processing to make sure said serial ATA bus is operating correctly in a normal non sleep mode when said “over” signal is detected.

10. The method of claim 9 further comprising the steps of monitoring said serial ATA bus for the transmission of said unique OOB pattern, and when said unique OOB pattern is detected and said reset signal is false, sending a signal to an OOB software process causing said process to start OOB reset interval processing.

11. The method of claim 10 wherein said step of monitoring for said unique OOB pattern comprises using a low power receiver to monitor for said unique OOB signal, said low power receiver coupled to the input(s) of a higher power receiver used to receive regular data when said ATA bus is operating in a non sleep normal mode, both said low power receiver and said higher power receiver being part of a transceiver coupled to said serial ATA bus, said low power receiver enabling monitoring for said unique OOB signal during power conservation sleep mode of said serial ATA bus when said higher power receiver is shut down.

12. The method of claim 11 further comprising the steps of using said low power receiver to monitor for the occurrence of said “over” signal, and when said “over” signal is detected, transmitting from the transmitter of the transceiver which detected said “over” signal a unique handshaking signal back to the transceiver which transmitted said “over” signal to serve as a confirmation that said unique OOB pattern transmitted by the transceiver which transmitted said “over” signal was properly received.

13. A method for use on any serial bus wherein normal operation including normal operation during sleep mode requires constant transmission of data or fill characters so that receivers coupled to said bus do not lose clock synchronization, for initiating predetermined processing to make sure that the bus is operating properly, comprising:
detecting occurrence of a master reset signal and responding thereto by transmitting on a serial bus a predetermined signal to indicate a need to commence predetermined processing to make sure said serial bus is operating correctly, said predetermined signal comprising at least one silent interval of a predetermined duration known to all transceivers coupled to said serial bus, each said silent interval ended by a burst of any data of any length, said predetermined signal comprising the transmission of said one or more silent intervals of predetermined duration(s) which are known to all transceivers coupled to said serial bus, said silent interval(s) transmitted in a predetermined pattern which also is known to all transceivers coupled to said serial bus;
sending a long silent interval at the end of said predetermined signal to indicate cessation of transmission of said predetermined signal, said long silent interval having a predetermined duration known to all transceivers coupled to said bus and different from the duration of any silent interval in said predetermined signal and hereafter referred to as the “over” signal;
detecting in each other transceiver coupled to said bus said silent interval(s) and measuring the duration of each one, and if said duration of said silent interval or the durations and pattern of durations of said silent intervals matches the known pattern(s) defining said predetermined signal, sending a signal to a reset software process to cause said reset software process to perform said predetermined processing;
upon detection of said “over” signal, transmitting a predetermined handshaking signal back to said transceiver which sent said predetermined signal, said handshaking signal being known to all transceivers coupled to said bus.

14. The method of claim 13 further comprising causing transmitters of each other said transceiver coupled to said serial bus and which detected said predetermined signal to stop transmitting data at least until data necessary to perform said predetermined processing must be transmitted.

15. A low power receiver apparatus for monitoring a serial data bus for the transmission of a unique signal pattern which indicates a need to perform reset processing to re-establish communications on said serial data bus, comprising:
a squelch detector having one or more inputs coupled to the receive lines of said serial bus and having an output line which is driven to a first state during silent intervals on said bus and which reverts to a second state whenever anything other than silence is being transmitted on said bus;
a timer having an enable count input coupled to said output line of said squelch detector and having either an internal clock driving a counter or a clock input for driving said counter, and having a data output at which the count of said counter appears, said timer functioning to count clock cycles only during silent intervals on said bus; and
a signal pattern detector having an input coupled to said output signal line and having a data input coupled to said data output of said timer, and functioning to calculate the duration of the one or more silent intervals on said bus that comprise said unique signal pattern and compare the durations of said one or more silent intervals to stored data defining how long these durations are in said unique signal pattern and the order, if any, in which the silent intervals of predetermined durations occur if said unique signal pattern is comprised of more than one silent interval of different durations, and for activating an output signal when said unique signal pattern is detected.

16. The apparatus of claim 15 wherein said signal pattern detector stores data defining two different unique signal patterns and has two different outputs the first of which carries a first output signal which is activated when a first unique signal pattern is detected and a second of which carries a second output signal which is activated when a second unique signal pattern is detected.

17. A transceiver for sending and receiving high speed data on a serial bus and monitoring for transmission of a unique reset signal pattern even during sleep mode, comprising:
a high speed transmitter coupled to a transmit line of a serial bus;
a high speed receiver coupled to a receive line of a serial bus;
a low power receiver means coupled in parallel to said receive line of said serial bus for monitoring said receive line to determine when said unique reset signal pattern has been transmitted.
